(19) United States
(12) Patent Application Publication
(10) Pub. No.: US 2018/0080831 A1
(43) Pub. Date: Mar. 22, 2018

(54) SHIELD PLATE AND MEASUREMENT APPARATUS

(71) Applicant: HAMAMATSU PHOTONICS K.K., Hamamatsu-shi, Shizuoka (JP)

(72) Inventor: Tomonori NAKAMURA, Hamamatsu-shi (JP)

(73) Assignee: HAMAMATSU PHOTONICS K.K., Hamamatsu-shi, Shizuoka (JP)

(21) Appl. No.: 15/559,430

(22) PCT Filed: May 24, 2016
(86) PCT No.: PCT/JP2016/065278

§ 371 Date: Sep. 19, 2017

(30) Foreign Application Priority Data
May 27, 2015 (JP) 2015-107800

(51) Int. Cl. G01J 5/06; G01J 5/20

(52) U.S. Cl. CPC G01J 5/061; G01J 2005/065; G01J 5/20

(57) ABSTRACT

A shield plate that is used for non-contact measurement of a temperature of a measurement target is provided. The shield plate includes a base of which a temperature is adjustable. The base includes a central shield portion that is formed in the shield plate, an opening that is formed around the central shield portion, and a blackbody surface that is formed on one surface of the base to include a portion opposite to the opening with the central shield portion interposed therebetween and to radiate infrared rays.

### TECHNICAL FIELD

An aspect of the present invention relates to a shield plate and a measurement apparatus that are used for temperature measurement of a measurement target.

### BACKGROUND ART

Conventionally, a method described in Patent Literature 1, for example, is known as a method of measuring the surface temperature of a measurement target such as a semiconductor apparatus without contact. In the method described in Patent Literature 1, two portions having different emissivity that are measurement targets are irradiated with heat rays using an auxiliary heat source (surface blackbody), and heat rays including heat rays generated by the measurement target and heat rays generated from the auxiliary heat source, which are reflected by the measurement target, are detected by the infrared camera. By changing the temperature of the auxiliary heat source to detect the heat rays, it is possible to detect the surface temperature of the measurement target having an unknown emissivity without contact with high accuracy.

### CITATION LIST

### Patent Literature

[Patent Literature 1] Japanese Unexamined Patent Publication No. 2012-127678

### SUMMARY OF INVENTION

### Technical Problem

Here, in Patent Literature 1, heat rays with which a measurement target is irradiated from an auxiliary heat source and heat rays generated by the measurement target cannot be disposed coaxially. That is, there is a path of heat rays with which the measurement target is irradiated from an auxiliary heat source, separate from a path of heat rays generated by the measurement target. In such a configuration, in order to irradiate the measurement target with heat rays from the auxiliary heat source, it is necessary to provide an auxiliary heat source at a position different from a position on a path coupling the measurement target to the infrared camera. Accordingly, the method of Patent Literature 1 can be applied only to an apparatus that measures a measurement target having a certain size, and cannot be applied to an apparatus in which a micro-optical system such as a semiconductor apparatus inspection apparatus or the like is used.

An aspect of the present invention has been made in view of the above circumstances, and an object thereof is to measure the surface temperature of a measurement target without contact with high accuracy in an apparatus of a micro-optical system.

### Solution to Problem

The inventor et al. has earnestly studied techniques of measuring a surface temperature of a measurement target in a non-contact manner in an apparatus of a micro optical system.

As a result, the inventor et al. has conceived a shield plate which is used for non-contact measurement of a temperature of a measurement target, which includes a base of which the temperature is adjustable, and in which a first surface located on one outer surface of the base is a blackbody surface. In the shield plate, the first surface which is a blackbody surface serves as an auxiliary heat source, and infrared rays (heat rays) are radiated from the first surface to the measurement target. When the first surface serving as an auxiliary heat source is disposed to face the measurement target, the shield plate is disposed between the measurement target and an imaging unit (an infrared detector) that captures infrared rays in a micro-optical system such as a semiconductor apparatus inspection apparatus. In this case, infrared rays including infrared rays which are obtained by causing the measurement target to reflect infrared rays radiated from the first surface and infrared rays which are generated by the measurement target can be detected by the imaging unit. Since the shield plate includes the base of which the temperature is adjustable, it is possible to detect infrared rays including infrared rays which are obtained by causing the measurement target to reflect infrared rays radiated from the first surface and infrared rays which are generated by the measurement target using the imaging unit while changing the temperature of the first surface serving as an auxiliary heat source. Accordingly, a micro-optical system such as a semiconductor apparatus inspection apparatus can also perform non-contact measurement of a surface temperature of a measurement target with unknown emissivity.

Here, when the shield plate is used to measure a temperature of a micro-optical system such as a semiconductor apparatus inspection apparatus, infrared rays including infrared rays which are generated by the measurement target and infrared rays which are reflected by the measurement target may be detected by the imaging unit. Accordingly, when only infrared rays generated by the measurement target are detected by the imaging unit, the infrared rays serve as noise components and accuracy of temperature measurement may degrade.

The inventor et al. found out the fact that the above-mentioned degradation of temperature measurement accuracy can be minimized by providing a shield area including a blackbody surface, forming an opening around the shield area, and allowing an area including an area opposite to the opening with the shield area interposed therebetween to serve a blackbody.

That is, a shield plate according to an aspect of the invention is a shield plate that is used for non-contact measurement of a temperature of a measurement target and includes a base of which a temperature is adjustable. The base includes a shield portion that is formed in the shield plate, an opening that is formed around the shield portion, and a blackbody portion that is formed on one surface of the base to include a portion opposite to the opening with the shield portion interposed therebetween and to radiate infrared rays.

The shield plate according to the aspect of the invention includes the shield portion. In this case, when the shield plate is disposed such that the shield portion of the shield plate is located on an optical axis of an imaging unit, the shield portion is disposed between the measurement target and the imaging unit on the optical axis of the imaging unit. When the shield portion of the shield plate is not located on the optical axis of the imaging unit, only infrared rays radiated from the measurement target may be transmitted to the imaging unit. Accordingly, by locating the shield portion of the shield plate on the optical axis of the imaging unit, it is possible to prevent only the infrared rays radiated from the measurement target from being transmitted to the imaging unit. The opening is formed around the shield portion and the blackbody portion radiating infrared rays is formed to include a portion opposite to the opening with the shield portion interposed therebetween. Since the opening and the blackbody portion are formed to be opposite to each other, infrared rays irradiated from the blackbody portion serving as an auxiliary heat source to the measurement target are reflected by the measurement target, passes through the opening, and reaches the imaging unit. Infrared rays generated by the measurement target also pass through the opening and reaches the imaging unit. Accordingly, since the opening and the blackbody portion are formed, infrared rays including infrared rays generated by the measurement target and infrared rays reflected by the measurement target are detected by the imaging unit. As described above, it is possible to prevent only infrared rays generated by the measurement target from being detected by the imaging unit thanks to the shield portion and to detect infrared rays including infrared rays generated by the measurement target and infrared rays reflected by the measurement target by the imaging unit thanks to the opening and the blackbody portion. Accordingly, in an apparatus of a micro-optical system, it is possible to perform non-contact measurement of a surface temperature of a measurement target with high accuracy.

The opening may be formed around the shield portion to be odd-fold rotationally symmetrical around the shield portion. Accordingly, in the shield plate, it is possible to make the opening and the blackbody portion satisfactorily opposite to each other. By forming the opening in a rotation symmetrical shape, it is possible to improve thermal conductivity of the shield plate and to improve temperature uniformity of the shield plate.

The opening may be formed in an annular shape around the blackbody portion. For example, when there are a portion in which the opening is formed and a portion in which the opening is not formed in a rotation direction about the shield portion, only a biased portion of a lens of the imaging unit, that is, an area of the lens of the imaging unit corresponding to the opening, is used. Accordingly, an image flow in an image based on infrared rays detected by the imaging unit may be a problem. When the image flow is a problem, it is necessary to measure a temperature while avoiding using of only a part of the lens by appropriately rotating the shield plate about the shield portion. Accordingly, since infrared rays passing through the opening having an annular shape are detected by the imaging unit, only a part of the lens included in the imaging unit is not used. As a result, the image flow does not serve as a problem and it is possible to measure a temperature without rotating the shield plate or the like.

The opening may be formed to decrease in size from the one surface of the base to the other surface of the base. Accordingly, it is possible to prevent only infrared rays radiated from the measurement target from being detected by the imaging unit.

The blackbody portion may include an area which surrounds an outer edge of a portion opposite to the opening with the shield portion interposed therebetween, and the area may be an area which is defined based on a size of an effective visual field of the imaging unit which is used to measure the temperature of the measurement target.

The imaging unit which is used to measure the temperature of the measurement target may image only infrared rays including infrared rays generated by the measurement target and infrared rays reflected by the measurement target as described above. The infrared rays reflected by the measurement target may be infrared rays which are obtained by causing the measurement target to reflect infrared rays radiated from the blackbody portion. When the effective visual field of the imaging unit is not considered, that is, when the size of the effective visual field is assumed to be 0, the infrared rays which are reflected by the measurement target and imaged by the imaging unit are only infrared rays which are obtained by causing the measurement target to reflect infrared rays radiated from the blackbody portion to the measurement target. However, the imaging unit actually also images infrared rays which are obtained by causing infrared rays radiated from an area outside the portion opposite to the opening with the shield portion interposed therebetween by the size of the effective visual field of the imaging unit. Accordingly, the area outside the portion opposite to the opening with the shield portion interposed therebetween by the size of the effective visual field of the imaging unit may be made to be a blackbody portion. In this regard, by disposing the blackbody portion to include an area corresponding to the size of the effective visual field of the imaging unit such that the outer edge of the portion opposite to the opening with the shield portion interposed therebetween, it is possible to make the infrared rays reflected by the measurement target be infrared rays which obtained by allowing the measurement target to reflect infrared rays radiated from the blackbody portion and thus to secure measurement accuracy.

The above-mentioned area may be an area which is defined by a trajectory along which a circumscribed circle of the effective visual field of the imaging unit is circulated around the portion opposite to the opening with the shield portion interposed therebetween. Accordingly, it is possible to satisfactorily make the infrared rays reflected by the measurement target be infrared rays which are obtained by allowing the measurement target to reflect infrared rays radiated from the blackbody portion.

According to an aspect of the invention, there is provided a measurement apparatus that performs non-contact measurement of a temperature of a measurement target, the measurement apparatus including: the above-mentioned shield plate that is disposed such that one surface of the base is opposite to the measurement target; a light guiding optical system that guides infrared rays passing through the opening of the shield plate; an infrared detector that is optically coupled to the light guiding optical system, detects the guided infrared rays, and outputs a detection signal; a temperature control unit that controls a temperature of the shield plate; and a calculation unit that calculates the temperature of the measurement target based on the detection signal, wherein the shield plate is disposed such that the shield portion is located on an optical axis of the light guiding optical system.

In the measurement apparatus, the shield plate includes the shield portion. The shield plate is disposed such that the shield portion is located on an optical axis of the light guiding optical system. When the shield portion of the shield plate is not located on the optical axis of the imaging unit, only infrared rays radiated from the measurement target may be transmitted from a portion which is not shielded to the imaging unit. In this regard, when the shield portion of the shield plate is located on the optical axis of the imaging unit, it is possible to prevent only the infrared rays radiated from the measurement target from being transmitted to the imaging unit. In the shield plate, the opening is formed around the shield portion and the blackbody portion is formed to include a portion opposite to the opening with the shield portion interposed therebetween. Since the opening and the blackbody portion are formed to be opposite to each other, infrared rays irradiated from the blackbody portion serving as an auxiliary heat source to the measurement target are reflected by the measurement target, passes through the opening, and reaches the imaging unit. Infrared rays generated by the measurement target also pass through the opening and reaches the imaging unit. Accordingly, since the opening and the blackbody portion are formed, infrared rays including infrared rays generated by the measurement target and infrared rays reflected by the measurement target are detected by the imaging unit. That is, for example, in a state in which a measuring signal is input from a signal input unit to the measurement target and the measurement target is driven, infrared rays are irradiated from the blackbody portion to the measurement target, and infrared rays including infrared rays reflected by the measurement target and infrared rays generated by the measurement target are detected by the imaging unit. The temperature of the base of the shield plate is adjusted by the temperature control unit. Accordingly, the infrared rays including infrared rays obtained by allowing the measurement target to reflect infrared rays irradiated to the measurement target and infrared rays generated by the measurement target can be detected by the imaging unit while changing the temperature of the blackbody surface as an auxiliary heat source. As a result, it is possible to perform non-contact measurement of the surface temperature of the measurement target having unknown emissivity with high accuracy. As described above, it is possible to prevent only infrared rays generated by the measurement target from being detected by the imaging unit thanks to the shield portion and to detect infrared rays including infrared rays generated by the measurement target and infrared rays reflected by the measurement target by the imaging unit thanks to the opening and the blackbody portion. As a result, in an apparatus of a micro-optical system, it is possible to perform non-contact measurement of a surface temperature of a measurement target with high accuracy.

The temperature control unit may control the temperature of the base of the shield plate such that the temperature is controlled to be at least a first temperature and a second temperature which is different from the first temperature, and the calculation unit may calculate the temperature of the measurement target based on the detection signal at the first temperature and the detection signal at the second temperature. The infrared detector may be a two-dimensional infrared detector.

### Advantageous Effects of Invention

According to the shield plate and the measurement apparatus, it is possible to measure the surface temperature of the measurement target without contact with high accuracy in an apparatus of a micro-optical system.

### BRIEF DESCRIPTION OF DRAWINGS

FIG. 1 is a diagram schematically illustrating a configuration of a measurement apparatus according to an embodiment of the present invention.

FIG. 2 is a plan view of a shield plate in the measurement apparatus of FIG. 1.

FIG. 3 is a cross-sectional view taken along line III-III of FIG. 2(a).

FIG. 4 is a bottom view of a shield plate according to a modification example.

FIG. 5 is a bottom view of a shield plate according to a modification example.

FIG. 6 is a bottom view of a shield plate according to a modification example.

FIG. 7 is a cross-sectional view of a shield plate according to a modification example.

### DESCRIPTION OF EMBODIMENTS

Hereinafter, embodiments of the present invention will be described in detail with reference to the drawings. In each figure, the same or corresponding portions are denoted with the same reference numerals, and repeated description thereof will be omitted.

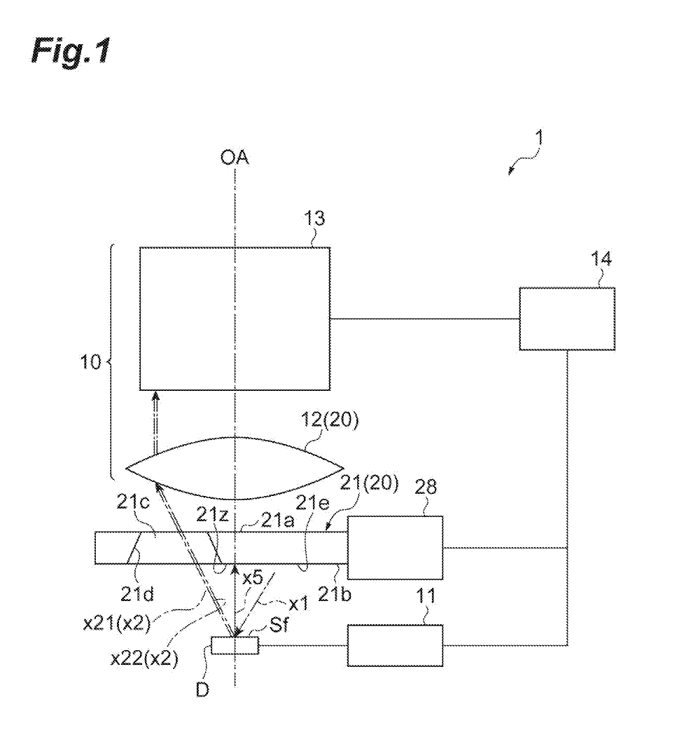

As illustrated in FIG. 1, a measurement apparatus 1 according to this embodiment is an apparatus (system) of a micro-optical system that measures temperature of a semiconductor apparatus D that is an apparatus under test (DUT) (a measurement target) without contact. More specifically, the measurement apparatus 1 measures the temperature of the semiconductor apparatus D without contact by performing heat observation in a state in which emissivity of the semiconductor apparatus D is unknown.

Examples of the semiconductor apparatus D include an integrated circuit having a PN junction such as a transistor (for example, a small scale integration (SSI), a medium scale integration (MSI), a large scale integration (LSI), a very large scale integration (VLSI), a ultra large scale integration (ULSI), a giga scale integration (GSI), a high current/high voltage MOS transistor or bipolar transistor, and a power semiconductor apparatus (power apparatus). Further, the semiconductor apparatus D is placed on a sample stage (not illustrated), for example. A measurement target is not limited to a semiconductor apparatus, and various apparatuses, such as a solar cell module such as a solar cell panel, can be the measurement target.

The measurement apparatus 1 includes a tester unit 11 (signal input unit), an objective lens 12 (light guiding optical system), an infrared camera 13 (imaging unit or infrared detector), a computer 14 (calculation unit), a shield plate 20, and a temperature controller 28 (temperature control unit) in a functional configuration related to temperature measurement of the semiconductor apparatus D.

The tester unit 11 is electrically coupled to the semiconductor apparatus D via a cable and functions as a signal input unit that applies a measurement signal to the semiconductor apparatus D. The tester unit 11 is operated by a power supply (not illustrated), and repeatedly applies a signal for driving the semiconductor apparatus D, a clock signal, or the like as the measurement signal. The tester unit 11 may apply a modulated current signal or may apply a continuous wave (CW) current signal. The tester unit 11 is electrically coupled to the computer 14 via a cable, and applies a signal designated from the computer 14 to the semiconductor apparatus D. The tester unit 11 may not necessarily be electrically coupled to the computer 14. When the tester unit 11 is not electrically coupled to the computer 14, the tester unit 11 determines a signal as a single unit and applies the signal to the semiconductor apparatus D.

The shield plate 20 is a member used for non-contact measurement of the temperature of the semiconductor apparatus D. The shield plate 20 is arranged between the semiconductor apparatus D and the objective lens 12, and more specifically, the shield plate 20 is provided so that a central shield portion 21z thereof is located on an optical axis OA of the objective lens 12. The shield plate 20 includes a base 21 of which a temperature can be adjusted according to control of the temperature controller 28. A member having high thermal conductivity and characteristics of a blackbody or a reflective material may be used as the base 21. Further, the base 21 may have a structure in which a fluid flows therein, a heating wire, or the like. For example, the base 21 may have a heat pipe, a rubber heater, or the like therein.

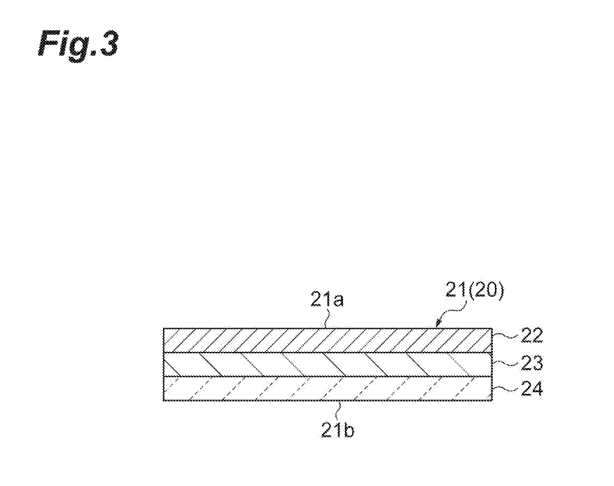

As illustrated in FIG. 3, the base 21 has a three-layer structure in which a substrate layer 23, a blackbody layer 24 (a first layer), and a reflective layer 22 (a second layer) are laminated. The substrate layer 23 conducts heat according to control of the temperature controller 28. The substrate layer 23 is provided to be sandwiched between the blackbody layer 24 and the reflective layer 22. Therefore, the substrate layer 23 and the blackbody layer 24, and the substrate layer 23 and the reflective layer 22 are thermally coupled. As the substrate layer 23, a member having high thermal conductivity capable of achieving a uniform temperature, such as a copper member (a copper plate or a copper layer), can be used. Further, the substrate layer 23 may have a structure in which a fluid flows therein, a heating wire, or the like. For example, the base 21 may include a heat pipe, a rubber heater, or the like therein.

The blackbody layer 24 is a layer in which a surface (outer surface) opposite to a surface in contact with the substrate layer 23 is a blackbody surface 21b. The blackbody surface 21b is a surface on one side in a stacking direction of the base 21. The blackbody surface 21b faces the semiconductor apparatus D. The blackbody layer 24 is subjected to, for example, Raydent (registered trademark) treatment or the like, and has a higher emissivity and a lower reflectance, that is, a larger amount of thermal radiation than the reflective layer 22. Accordingly, at least a portion of the blackbody surface 21b is in a blackbody state with respect to infrared rays. The amount of thermal radiation of the blackbody surface 21b in the blackbody state is larger than the amount of thermal radiation of a reflective surface 21a (which will be described in detail below) which is a surface on a side opposite to the blackbody surface 21b of the base 21, that is, a surface on the other side in a stacking direction of the base 21. A black ceramic coating film, for example, can be used as the blackbody layer 24. The blackbody refers to an object (complete blackbody) capable of completely absorbing electromagnetic waves incident from the outside over all wavelengths and radiating heat, but the blackbody state in this embodiment does not refer to a state in which a blackbody is a complete blackbody, and refers to a state in which the same degree of thermal radiation as a blackbody with respect to at least infrared rays can be realized. The state in which the same degree of thermal radiation as a blackbody can be realized refers to, for example, a state in which the emissivity is 90% or more.

The reflective layer 22 is a layer in which a surface (outer surface) opposite to a surface in contact with the substrate layer 23 is a reflective surface 21a. That is, the reflective layer 22 is provided so that the substrate layer 23 is sandwiched between the reflective layer 22 and the blackbody layer 24. The reflective surface 21a faces the objective lens 12. That is, the reflective surface 21a is a surface located on the opposite side to the blackbody surface 21b in the base 21. As the reflective layer 22, a member having high reflectance of the reflective surface 21a at a detection wavelength of the infrared camera 13, such as gold plating, can be used. The reflective surface 21a becomes a mirror surface due to high reflectance (for example, 90% or more). Therefore, the infrared camera 13 is in a Narcissus state (a state in which the infrared camera 13 views itself). Accordingly, it is possible to prevent a dark level of the infrared camera 13 from being changed according to a change in the temperature of the base 21 and to improve the SN.

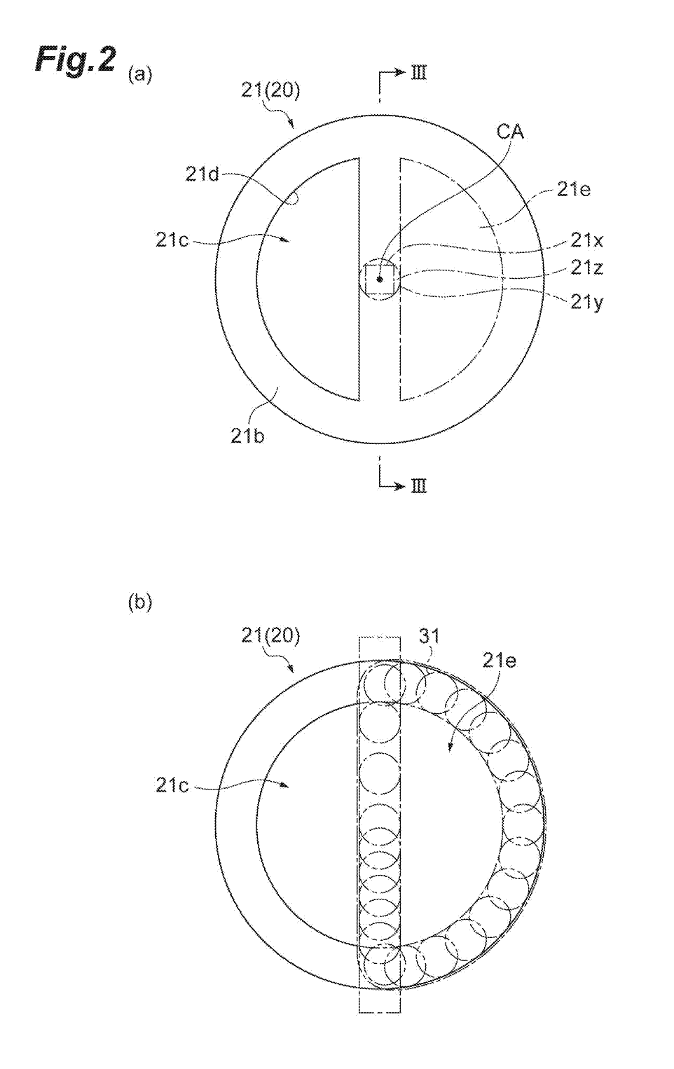

As illustrated in FIG. 2, the base 21 has the central shield portion 21z (shield portion) formed around a central axis CA of the shield plate 20 on the blackbody surface 21b. The central shield portion 21z is formed in a area of a circumscribed circle 21y of an effective visual field 21x depending on an imaging unit 10 (which includes at least the infrared camera 13 and the objective lens 12) around the central axis CA. A size of the effective visual field 21x depending on the imaging unit 10 is determined by the performance or an arrangement relationship between the objective lens 12 and the infrared camera 13 included in the imaging unit 10. By forming the central shield portion 21z, a heat ray x5 (see FIG. 1) near the optical axis OA among the heat rays radiated from the semiconductor apparatus D to the infrared camera 13 is not transferred to the infrared camera 13.

Here, in a temperature deriving method in the computer 14 to be described below, the heat rays including the heat rays radiated from the semiconductor apparatus D and the heat rays reflected in the semiconductor apparatus D are detected by the infrared camera 13 and, therefore, the temperature is derived. The heat rays reflected by the semiconductor apparatus D are heat rays reflected by the semiconductor apparatus D according to the heat rays radiated from the blackbody surface 21b to the semiconductor apparatus D. If the central shield portion 21z is not provided and the area of the central axis CA in the base 21 has an open form, no blackbody is provided directly above the semiconductor apparatus D on the central axis CA. In this case, there are no heat rays on the central axis CA, which are heat rays reflected by the semiconductor apparatus D according to the heat rays radiated from the blackbody surface 21b to the semiconductor apparatus D as described above. Therefore, the heat rays passing through the central axis CA and detected by the infrared camera 13 are only the heat rays radiated from the semiconductor apparatus D, and there is a concern that the temperature may not be able to be appropriately measured using the above-described temperature deriving method. In this respect, by providing the central shield portion 21z, it is possible to prevent only the heat rays radiated from the semiconductor apparatus D from being detected by the infrared camera 13.

Further, the base 21 includes an opening 21c formed around the central shield portion 21z. More specifically, the opening 21c is formed adjacent to the circumscribed circle 21y in the blackbody surface 21b and in a semicircular shape when viewed from a bottom surface. Only one opening 21c is formed around the central shield portion 21z so that the opening 21c is one-fold rotationally symmetrical around the central shield portion 21z. The opening 21c is formed to penetrate the base 21 from the blackbody surface 21b to the reflective surface 21a (see FIG. 1). Further, the opening 21c is formed such that the opening shape gradually decreases from the blackbody surface 21b side toward the reflective surface 21a side. More specifically, an inner circumferential surface 21d of the opening 21c that defines a region of the opening 21c has an oblique structure approaching a center of the opening 21c from the blackbody surface 21b side to the reflective surface 21a side (See FIG. 1). The inner circumferential surface 21d is subjected to Raydent (registered trademark) treatment or the like and is in a blackbody state. The oblique structure of the inner circumferential surface 21d is determined in consideration of a viewing angle of the infrared camera 13 so that the inner circumferential surface 21d cannot be observed from the infrared camera 13. Due to the inner circumferential surface 21d having such an oblique structure, only heat rays generated from the semiconductor apparatus D being reflected by the inner circumferential surface 21d and detected by the infrared camera 13 can be prevented.

Further, the base 21 has an opposite shield portion 21e (blackbody portion) in a blackbody state formed on the blackbody surface 21b to face the opening 21c with the central shield portion 21z sandwiched therebetween. More specifically, the opposite shield portion 21e is formed to include a region that faces the opening 21c around the central axis CA. A size (an area) of the opposite shield portion 21e may be smaller than a size (an area) of the opening 21c in the blackbody surface 21b. As illustrated in FIG. 2, a shape and a size of the opposite shield portion 21e may be substantially coincident with a shape and a size of the opening 21c in the blackbody surface 21b.

As illustrated in FIG. 1, the semiconductor apparatus D is irradiated with a heat ray x1 from the opposite shield portion 21e that is in a blackbody state. In the semiconductor apparatus D, a heat ray x21 is reflected according to the heat ray x1. The heat ray x21 reaches the opening 21c that faces the opposite shield portion 21e. Further, a heat ray x22 generated in the semiconductor apparatus D reaches the opening 21c. That is, heat rays x2 including the heat ray x21 reflected by the semiconductor apparatus D and the heat ray x22 generated by the semiconductor apparatus D reach the opening 21c. The heat rays x2 pass through the opening 21c and are detected by the infrared camera 13 via the objective lens 12.

Here, almost all heat rays detected by the infrared camera 13 may be the heat rays x2 in order to ensure accuracy of temperature derivation in the computer 14. That is, the heat rays reflected by the semiconductor apparatus D, which are detected by the infrared camera 13, may be the heat ray x21 reflected by the semiconductor apparatus D according to the heat rays with which the semiconductor apparatus D is irradiated from the opposite shield portion 21e which is a surface in a blackbody state. When the effective visual field 21x depending on the imaging unit 10 is not considered, that is, when a size of the effective visual field 21x depending on the imaging unit 10 is assumed to be 0, all the heat rays reflected by the semiconductor apparatus D, which are detected by the infrared camera 13, can be the heat ray x21 by providing the above-described opposite shield portion 21e. However, in reality, the infrared camera 13 detects heat rays reflected by the semiconductor apparatus D other than the heat ray x21 according to the size of the effective visual field 21x depending on the imaging unit 10. Specifically, the infrared camera 13 detects the heat rays reflected by the semiconductor apparatus D according to the heat rays with which the semiconductor apparatus D is irradiated from a region (hereinafter referred to as a peripheral region) between an outer edge of a region of the opposite shield portion 21e and a position further outside by a diameter of the circumscribed circle 21y of the effective visual field 21x from the outer edge. In order to cause the heat ray to be the same as the above-described heat ray x21, it is necessary to set the peripheral region to be in the same blackbody state as the opposite shield portion 21e. Therefore, in the above-described peripheral region, a peripheral shield portion 31 (blackbody portion) that is in a blackbody state like the opposite shield portion 21e is provided to surround the outer edge of the opposite shield portion 21e. The peripheral shield portion 31 is provided in a region defined according to the effective visual field depending on the imaging unit 10. More specifically, the peripheral shield portion 31 is provided in a region defined by a trajectory along which the circumscribed circle 21y of the effective visual field 21x depending on the imaging unit 10 is rotated around the opposite shield portion 21e.

Referring back to FIG. 1, the temperature controller 28 is a temperature control unit that controls the temperature of the shield plate 20. The temperature controller 28 is a temperature adjustor such as a heater or a cooler that is thermally coupled to the shield plate 20 and controls the temperature of the shield plate 20 by conducting heat to the shield plate 20. The temperature controller 28 controls the temperature of the shield plate 20 according to a setting from the computer 14. For example, the temperature controller 28 may control the temperature of the shield plate 20 by conducting heat to the shield plate 20 (the base 21) through a liquid, a heating wire, or the like.

The objective lens 12 is a light guiding optical system that guides the heat ray x2 passing through the opening 21c of the shield plate 20 to the infrared camera 13. The objective lens 12 is provided so that an optical axis thereof is coincident with the optical axis OA.

The infrared camera 13 is an infrared detector that images the heat ray x2 emitted from the semiconductor apparatus D driven according to the input of the measurement signal via the objective lens 12. The infrared camera 13 includes a light reception surface in which a plurality of pixels that convert infrared rays into an electric signal are two-dimensionally arranged. The infrared camera 13 generates an infrared image (thermal image data (detection signal)) by imaging the heat rays, and outputs the infrared image to the computer 14. A two-dimensional infrared detector such as an InSb camera, for example, is used as the infrared camera 13. The infrared detector is not limited to a two-dimensional infrared detector, and a one-dimensional infrared detector such as a bolometer, or a point infrared detector may be used. Further, electromagnetic waves (light) having a wavelength of 0.7 μm to 1000 μm are generally referred to as infrared ray. Further, electromagnetic waves (light) in a region from mid-infrared rays having a wavelength of 2 μm to 1000 μm to far-infrared rays are referred to as heat rays, but there is no particular distinction in this embodiment, and heat rays refer to electromagnetic waves having a wavelength of 0.7 μm to 1000 μm, similar to infrared rays.

The computer 14 is electrically coupled to the infrared camera 13. The computer 14 derives the temperature of the semiconductor apparatus D based on the infrared image generated by the infrared camera 13. The computer 14 includes a processor that executes a function of deriving the temperature of the semiconductor apparatus D. Hereinafter, a derivation principle of temperature derivation based on the infrared image will be described.

In the semiconductor apparatus D, it is assumed that an area 1 which is an area with a constant emissivity and an area 2 which is an area with a constant emissivity lower than the emissivity of the area 1 are adjacent to each other. If the emissivity and reflectance of the respective areas are ρ1, ε1 and ρ2, ε2, Equations (1) and (2) below are satisfied due to Kirchhoff's law. Hereinafter, the area 1 with emissivity of ρ₁ may be referred to as a high emissivity portion, and the area 2 with emissivity of ρ₂ may be referred to as a low emissivity portion.

[Math. 1]

ρ₁+ε₁=1 (1)

[Math. 2]

ρ₂+ε₂=1 (2)

Here, if a thermal radiation luminance (the amount of thermal radiation) of the shield plate 20 is L_{low}, the radiation detected by the infrared camera 13 for the high emissivity portion is S_{1low}, radiation detected by the infrared camera 13 for the low emissivity portion is S_{2low}, and the thermal radiation luminance of the blackbody of temperature T is L(T), Equations (3) and (4) below are satisfied. S_{1low} can be referred to as the thermal radiation luminance in the high emissivity portion, and S_{2low} can be referred to as the thermal radiation luminance in the low emissivity portion. That is, Equation (3) below shows that, when the thermal radiation luminance of the shield plate 20 is L_{low}, heat rays having the thermal radiation luminance of S_{1low} in which heat rays generated by semiconductor apparatus D, which are radiated from the high emissivity portion of the semiconductor apparatus D and the heat rays reflected by the semiconductor apparatus D are superimposed are detected by the infrared camera 13. Further, Equation (4) below shows that, when the thermal radiation luminance of the shield plate 20 is L_{low}, heat rays having the thermal radiation luminance of S_{2low} in which heat rays generated by semiconductor apparatus D, which are radiated from the low emissivity portion of the semiconductor apparatus D and the heat rays reflected by the semiconductor apparatus D are superimposed are detected by the infrared camera 13.

[Math. 3]

S_{1low}<ε₁L(T)+ρ₁L_{low}=(1−ρ₁)L(T)+ρ₁L_{low} (3)

[Math. 4]

S_{1low}<ε₁L(T)+ρ₁L_{low}=(1−ρ₁)L(T)+ρ₁L_{low} (3)

Similarly, when the thermal radiation luminance of the shield plate 20 is L_{high} and if the radiation detected by the infrared camera 13 with respect to the high emissivity portion is S_{1High}, the radiation detected by the infrared camera 13 with respect to the low emissivity portion is S_{2High}, and the thermal radiation luminance of the blackbody state at a temperature T of the semiconductor apparatus D is L(T), Equations (5) and (6) below are satisfied.

$$\begin{matrix}[ Math . 5 ] & \\ \begin{matrix}{S}_{1 high} = {ɛ}_{1} L ( T ) + {ρ}_{1} {L}_{high} = ( 1 - {ρ}_{1} ) L ( T ) + {ρ}_{1} {L}_{high} \\ = L ( T ) + {ρ}_{1} ( {L}_{high} - L ( T ) )\end{matrix} & ( 5 ) \\ [ Math . 6 ] & \\ \begin{matrix}{S}_{2 high} = {ɛ}_{2} L ( T ) + {ρ}_{2} {L}_{high} = ( 1 - {ρ}_{2} ) L ( T ) + {ρ}_{2} {L}_{high} \\ = L ( T ) + {ρ}_{2} ( {L}_{high} - L ( T ) )\end{matrix} & ( 6 )\end{matrix}$$

A ratio R of reflectance of the high emissivity portion and reflectance of the low emissivity portion is expressed by Equation (7) below from Equations (3) to (6) above.

[Math. 7]

R=ρ₁/ρ₂=(S_{1high}−S_{1low})/(S_{2high}−S_{2low}) (7)

Equation (8) below is derived from Equation (3), (4), and (7) described above.

[Math. 8]

R=(S_{1high}−L(T))/(S_{2high}−L(T)) (8)

Similarly, Equation (9) below is derived from Equation (5), (6), and (7) described above.

[Math. 9]

R=(S_{1low}−L(T))/(S_{2low}−L(T)) (9)

If Equation (8) described above is modified,

[Math. 10]

L(T)=(S_{1high}−RS_{2high})/(1−R) (10)

since the thermal radiation luminance L(T) is obtained at a temperature T of the semiconductor apparatus D that is a measurement target from Equation (10), temperature of the semiconductor apparatus D can be derived from the thermal radiation luminance.

Next, a procedure of measuring the temperature of the semiconductor apparatus D using the shield plate 20 will be described.

First, the semiconductor apparatus D is placed on a sample stage (not illustrated) of the measurement apparatus 1. The tester unit 11 is electrically coupled to the semiconductor apparatus D, and a measurement signal such as a signal for driving the semiconductor apparatus D and a clock signal is input from the tester unit 11.

Subsequently, the temperature of the shield plate 20 is controlled by the temperature controller 28 such that it becomes a temperature at which the thermal radiation luminance of the blackbody surface 21b of the shield plate 20 and, more specifically, the opposite shield portion 21e is L_{low}. In this case, the semiconductor apparatus D is irradiated with heat rays of which the thermal radiation luminance is L_{low} from the shield plate 20.

Heat rays including heat rays generated by the semiconductor apparatus D and heat rays reflected by the semiconductor apparatus D according to the heat rays from the shield plate 20 pass through the opening 21c and the objective lens 12 of the shield plate 20, and are detected by the infrared camera 13. The infrared camera 13 images the heat rays and generates the infrared image. The infrared image includes radiations of two areas with different emissivity, that is, the high emissivity portion and the low emissivity portion. The computer 14 identifies radiation S_{1low} of the high emissivity portion and radiation S_{2low} of the low emissivity portion from the infrared image.

Subsequently, the temperature of the shield plate 20 is controlled by the temperature controller 28 to be temperature at which the thermal radiation luminance of the blackbody surface 21b of the shield plate 20 and, more specifically, the opposite shield portion 21e is L_{high}. In this case, the semiconductor apparatus D is irradiated with heat rays of which the thermal radiation luminance is L_{high} from the shield plate 20.

Heat rays including heat rays generated by the semiconductor apparatus D and heat rays reflected by the semiconductor apparatus D according to the heat rays from the shield plate 20 pass through the opening 21c and the objective lens 12 of the shield plate 20, and are detected by the infrared camera 13. The infrared camera 13 images the heat rays and generates the infrared image. The infrared image includes radiations of two areas with different emissivity, that is, the high emissivity portion and the low emissivity portion. The computer 14 identifies radiation S_{1high} of the high emissivity portion and radiation S_{2high} of the low emissivity portion from the infrared image.

Finally, the temperature of the semiconductor apparatus D is derived by the computer 14 from the radiation S_{1low} of the high emissivity portion and the radiation S_{2low} of the low emissivity portion based on the heat rays with the thermal radiation luminance of L_{low} and the radiation S_{1high} of the high emissivity portion and the radiation S_{2high} of the low emissivity portion based on the heat rays with the thermal radiation luminance of L_{high}.

The procedure of measuring the temperature of the semiconductor apparatus D has been described above, but the temperature measurement using the present invention is not limited to the above procedure. For example, the temperature of the shield plate 20 may be changed by the temperature controller 28 to a temperature at which the thermal radiation luminance is changed from L_{low} from L_{high}, and another shield plate different from the shield plate 20 may be provided and the shield plate 20 may be replaced with the other shield plate. In this case, for example, by setting the thermal radiation luminance of the shield plate 20 to L_{high} and the thermal radiation luminance of the other shield plate to L_{low}, it is possible to change the amount of thermal radiation with which the semiconductor apparatus D is irradiated. Further, zero point correction of the infrared camera 13 may be performed by arranging a sample coated with a metal (for example, gold or aluminum) having a very high emissivity as a measurement target to face the objective lens 12 in a state in which a shield plate 20 is not arranged, and detecting a dark state in which there are no heat rays emitted by the sample using the infrared camera 13 before the above-described procedure is performed.

Next, an operation and effects of the shield plate 20, and the measurement apparatus 1 including the shield plate 20 will be described.

In the shield plate 20, the periphery of the central axis of the shield plate 20 is covered with the central shield portion 21z. When the shield plate 20 is disposed such that the central axis of the shield plate 20 agrees to the optical axis OA, the central shield portion 21z is disposed directly above the semiconductor apparatus D. When a portion directly above the semiconductor apparatus D is not shielded, only heat rays generated by the semiconductor apparatus D may be transmitted from the portion which is not shielded to the infrared camera 13, which is not preferable in securing temperature measurement accuracy. In this regard, by disposing the central shield portion 21z directly above the semiconductor apparatus D, it is possible to prevent only heat rays generated by the semiconductor apparatus D from being transmitted to the infrared camera 13. The opening 21c is formed around the central shield portion 21z, and an opposite shield portion 21e which is in a blackbody state is formed to be opposite to the opening 21c with the central shield portion 21z interposed therebetween. Since the opening 21c and the opposite shield portion 21e are formed to be opposite to each other, heat rays irradiated from the opposite shield portion 21e of the blackbody surface 21b as an auxiliary heat source to the semiconductor apparatus D are reflected by the semiconductor apparatus D, passes through the opening 21c, and reaches the infrared camera 13. Heat rays generated by the semiconductor apparatus D also reaches the infrared camera 13 through the opening 21c. Accordingly, by forming the opening 21c and the opposite shield portion 21e, heat rays including heat rays generated by the semiconductor apparatus D and heat rays reflected by the semiconductor apparatus D are detected by the infrared camera 13. As described above, the central shield portion 21z can prevent only heat rays generated by the semiconductor apparatus D from being detected by the infrared camera 13, and the opening 21c and the opposite shield portion 21e enable the infrared camera 13 to detect heat rays including heat rays generated by the semiconductor apparatus D and heat rays reflected by the semiconductor apparatus D. Accordingly, in an apparatus of a micro-optical system, it is possible to perform non-contact measurement of the surface temperature of a measurement target with high accuracy.

The base 21 further includes a peripheral shield portion 31 in a blackbody state which surrounds the outer edge of the opposite shield portion 21e, and the peripheral shield portion 31 is an area which is defined by the size of the effective visual field of the imaging unit 10. As described above, the infrared camera 13 may image only the heat rays including heat rays generated by the semiconductor apparatus D and heat rays reflected by the semiconductor apparatus D. The heat rays reflected by the semiconductor apparatus D may be heat rays which are obtained by allowing the semiconductor apparatus D to reflect heat rays from the surface in a blackbody state (for example, the opposite shield portion 21e). When the effective visual field of the imaging unit 10 is not considered, that is, when it is assumed that the size of the effective visual field is 0, the heat rays which are reflected by the semiconductor apparatus D and imaged by the infrared camera 13 are only heat rays which are obtained by allowing the semiconductor apparatus D to reflect heat rays irradiated from the opposite shield portion 21e to the semiconductor apparatus D. However, the infrared camera 13 actually also images heat rays which are obtained by allowing the semiconductor apparatus D to reflect heat rays irradiated from an area outside the opposite shield portion 21e by an area corresponding to the size of the effective visual field of the imaging unit 10 to the semiconductor apparatus D. Accordingly, the area outside the opposite shield portion 21e by the area corresponding to the size of the effective visual field may be made to be in a blackbody state. In this regard, by disposing the peripheral shield portion 31 in the blackbody state by the size of the effective visual field of the imaging unit 10 to surround the outer edge of the opposite shield portion 21e, the heat rays reflected by the semiconductor apparatus D can be made to be heat rays which obtained by allowing the semiconductor apparatus D to reflect heat rays from a surface in a blackbody state, and it is thus possible to secure measurement accuracy.

The peripheral shield portion 31 is disposed in an area which is defined by a trajectory along which a circumscribed circle 21y of the effective visual field of the imaging unit 10 is circulated around the opposite shield portion 21e. Accordingly, it is possible to satisfactorily make the heat rays reflected by the semiconductor apparatus D be heat rays which are obtained by allowing the semiconductor apparatus D to reflect heat rays radiated from the surface in the blackbody state.

The measurement apparatus 1 is a measurement apparatus that performs non-contact measurement of the temperature of the semiconductor apparatus D, and includes the above-mentioned shield plate 20, a temperature controller 28 that adjustably controls the temperature of the shield plate 20, a tester unit 11 that inputs a measuring signal to the semiconductor apparatus D, and an infrared camera 13 that images heat rays from the semiconductor apparatus D. In the measurement apparatus 1, the periphery of the central axis of the shield plate 20 on the blackbody surface 21b in the shield plate 20 is covered with the central shield portion 21z in the blackbody state. The shield plate 20 is disposed such that the central axis thereof agrees to the optical axis OA of the heat rays directed from the semiconductor apparatus D to the infrared camera 13. Accordingly, the central shield portion 21z is disposed directly above the semiconductor apparatus D. When a portion directly above the semiconductor apparatus D is not shielded, only heat rays generated by the semiconductor apparatus D may be transmitted from the portion which is not shielded to the infrared camera 13. In this regard, by disposing the central shield portion 21z directly above the semiconductor apparatus D, it is possible to prevent only heat rays generated by the semiconductor apparatus D from being transmitted to the infrared camera 13. In the shield plate 20, the opening 21c is formed around the central shield portion 21z and the opposite shield portion 21e in the blackbody state is formed to be opposite to the opening 21c with the central shield portion 21z interposed therebetween. Since the opening 21c and the opposite shield portion 21e are formed to be opposite to each other, heat rays irradiated from the opposite shield portion 21e of the blackbody surface 21b as an auxiliary heat source to the semiconductor apparatus D are reflected by the semiconductor apparatus D, passes through the opening 21c, and reaches the infrared camera 13. The heat rays generated by the semiconductor apparatus D also reaches the infrared camera 13 through the opening 21c. Accordingly, by forming the opening 21c and the opposite shield portion 21e, heat rays including heat rays generated by the semiconductor apparatus D and heat rays reflected by the semiconductor apparatus D are detected by the infrared camera 13. That is, for example, in a state in which a measuring signal is input from the tester unit 11 to the semiconductor apparatus D and the semiconductor apparatus D is driven, heat rays are irradiated from the opposite shield portion 21e of the blackbody surface 21b to the semiconductor apparatus D, and heat rays including heat rays reflected by the semiconductor apparatus D and heat rays generated by the semiconductor apparatus D are detected by the infrared camera 13. The temperature of the base 21 of the shield plate 20 is adjusted by the temperature controller 28. Accordingly, the heat rays including heat rays reflected by the semiconductor apparatus D and heat rays generated by the semiconductor apparatus D can be detected by the infrared camera 13 while changing the temperature of the blackbody surface 21b as an auxiliary heat source. As a result, it is possible to perform non-contact measurement of the surface temperature of the semiconductor apparatus D having unknown emissivity with high accuracy. As described above, it is possible to prevent only heat rays generated by the semiconductor apparatus D from being detected by the infrared camera 13 thanks to the central shield portion 21z and to detect heat rays including heat rays generated by the semiconductor apparatus D and heat rays reflected by the semiconductor apparatus D by the infrared camera 13 thanks to the opening 21c and the opposite shield portion 21e. As a result, in an apparatus of a micro-optical system, it is possible to perform non-contact measurement of a surface temperature of a measurement target with high accuracy.

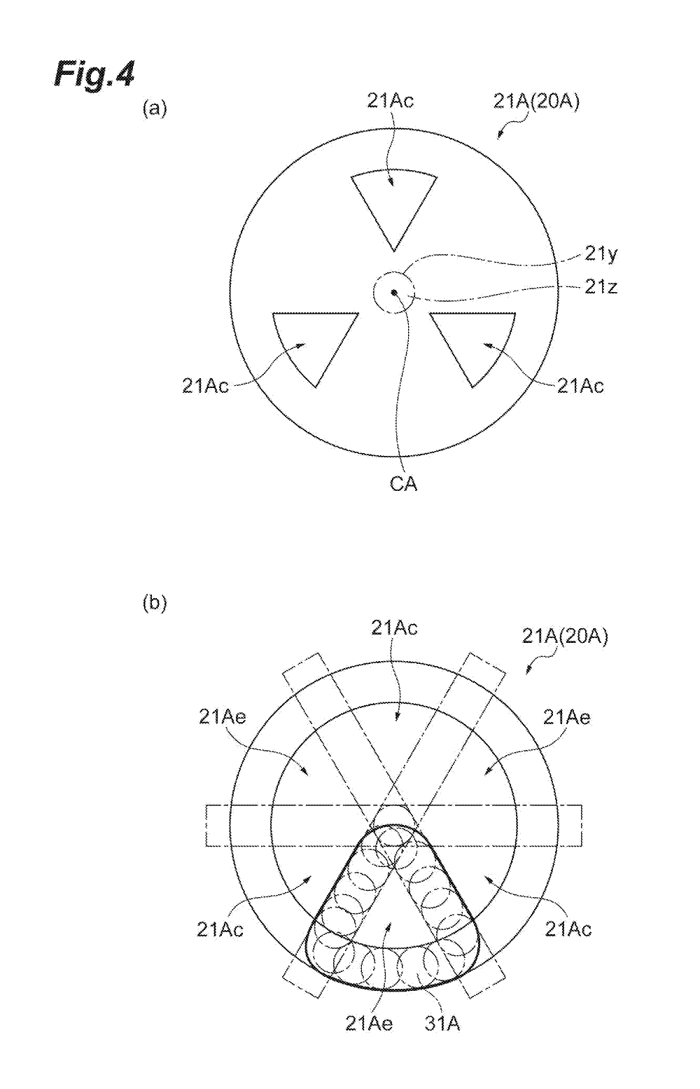

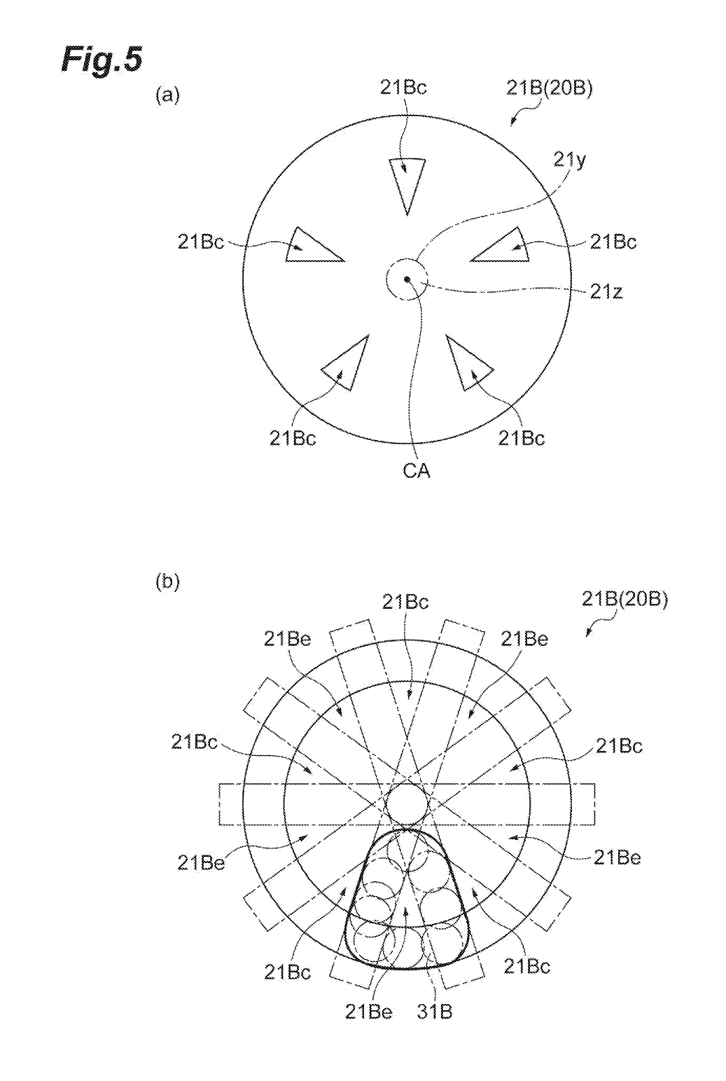

The first embodiment of the present invention has been described, but an aspect of the present invention is not limited to the first embodiment. For example, the case in which one opening 21c is formed in the shield plate 20 to be one-fold rotationally symmetrical around the central shield portion 21z has been described, but the present invention is not limited thereto and the opening may be formed around the central shield portion 21z to be odd-number-fold rotationally symmetrical around the central shield portion 21z. By providing the opening to be odd-number-fold rotationally symmetrical, it is possible to achieve a shape in which the opening reliably faces the facing shield portion. Further, by forming the opening in a rotationally symmetrical manner, it is possible to improve thermal conductivity of the shield plate and to improve temperature uniformity of the shield plate. Specifically, an example in which the opening is provided to be odd-number-fold rotationally symmetrical will be described with reference to FIGS. 4 and 5.

In a base 21A of a shield plate 20A illustrated in FIG. 4, openings 21Ac are formed around a central shield portion 21z so that the openings 21Ac are three-fold rotationally symmetrical around the central shield portion 21z. The opening 21Ac has a fan shape, and the three openings 21Ac are formed at equal intervals around the central shield portion 21z. Further, opposite shield portions 21Ae in a blackbody state are provided to face the openings 21Ac around the central axis CA. A shape and a size of the facing shield portion 21Ae is substantially coincident with a shape and a size of the opening 21Ac on a blackbody surface. Further, a peripheral shield portion 31A that is in a blackbody state like the opposite shield portion 21Ae is provided to surround the outer edge of the opposite shield portion 21Ae in a peripheral region that is a region between an outer edge of a region of the opposite shield portion 21Ae and a position on the outer side by a diameter of the circumscribed circle 21y of the effective visual field 21x from the outer edge.

In a base 21B of a shield plate 20B illustrated in FIG. 5, openings 21Bc are formed around a central shield portion 21z so that the openings 21Bc are five-fold rotationally symmetrical around a central shield portion 21z. The opening 21Bc has a fan shape, and five opening 21Bc are formed at equal intervals around the central shield portion 21z. Further, opposite shield portions 21Be in a blackbody state are provided to face the openings 21Bc around the central axis CA. A shape and a size of the facing shield portion 21Be is substantially coincident with a shape and a size of the opening 21Bc on a blackbody surface. Further, a peripheral shield portion 31B that is in a blackbody state like the opposite shield portion 21Be is provided to surround the outer edge of the opposite shield portion 21Be in a peripheral region that is a region between an outer edge of a region of the opposite shield portion 21Be and a position on the outer side by a diameter of the circumscribed circle 21y of the effective visual field 21x from the outer edge.

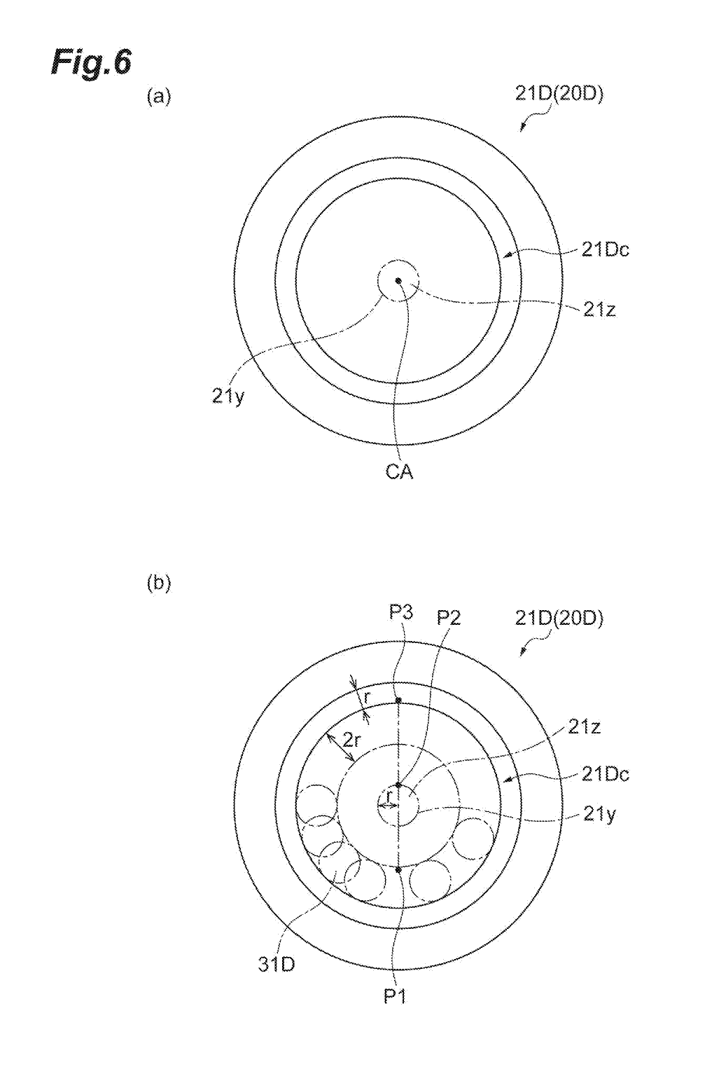

Further, as in a base 21D of a shield plate 20D illustrated in FIG. 6, an opening 21Dc may be formed in an annular shape around an opposite shield portion 31D (blackbody portion). In the base 21D, a central shield portion 21z in a blackbody state is formed to cover a central axis CA. The central shield portion 21z is formed in an area of a circumscribed circle 21y of an effective visual field 21x of an imaging unit 10 centered on the central axis CA. Further, if a radius of the circumscribed circle 21y is r, the opening 21Dc is formed from a position of 5r to a position of 6r from a center of the circumscribed circle 21y. That is, a width of the opening 21Dc having an annular shape is r. Further, the opposite shield portion 31D in the blackbody state is provided in a region between an inner edge of the opening 21Dc and a position further inside by a diameter (2r) of the circumscribed circle 21y from the inner edge. The opposite shield portion 31D serves as a blackbody portion. That is, the opposite shield portion 31D is formed on a blackbody surface to face the opening 21Dc around a region on the opening 21Dc side from a center of the central shield portion 21z. For example, a shield point P that is one point of the opposite shield portion 31D faces an opening point P3 of the opening 21Dc around a center point P2 that is a point on the opposite opening 21Dc side relative to the center of the central shield portion 21z in the central shield portion 21z. Although not illustrated in FIG. 6, it is not necessary for an inner side of the opening 21Dc to be actually supported or for heat to be conducted, and therefore, at least one portion of the opening 21Dc can be physically coupled to an inner edge of the opening 21Dc and an outer edge of the opening 21Dc.

For example, when there are a portion in which the opening is formed and a portion in which the opening is not formed in a rotation direction around the central axis CA of the shield plate 20D, only a biased portion of a lens between an infrared camera and a measurement target is used, and an image flow in an image based on heat rays detected by an infrared camera may be a problem. When image flow is a problem, heat rays may be detected by the infrared camera while appropriately rotating the shield plate around the central axis CA, for example. By doing so, the temperature can be measured while preventing only a portion of the lens from being used. For example, if the shield plate is a one-fold rotationally symmetrical shield plate 20 illustrated in FIG. 2, heat rays are detected a plurality of times by the infrared camera while rotating the shield plate 20 at least once (rotating the shield plate 20 by 3600), and images based on a plurality of heat rays are integrated to reduce image flow (if the shield plate is a three-fold rotationally symmetrical shield plate 20A illustrated in FIG. 4, the shield plate 20A is rotated by at least ⅓ (rotated by 120°), and if the shield plate is a five-fold rotationally symmetrical shield plate 20B illustrated in FIG. 5, the shield plate 20B is rotated by at least ⅕ (rotated by 72°). In the shield plate 20D in which the opening 21Dc is annularly formed, heat rays passing through the opening 21Dc having an annular shape are detected by the infrared camera, and therefore, not only a portion of the lens between the infrared camera and the measurement target is used. Accordingly, it is difficult for the above-described image flow to occur and measurement can be performed without performing rotation of the shield plate or the like.

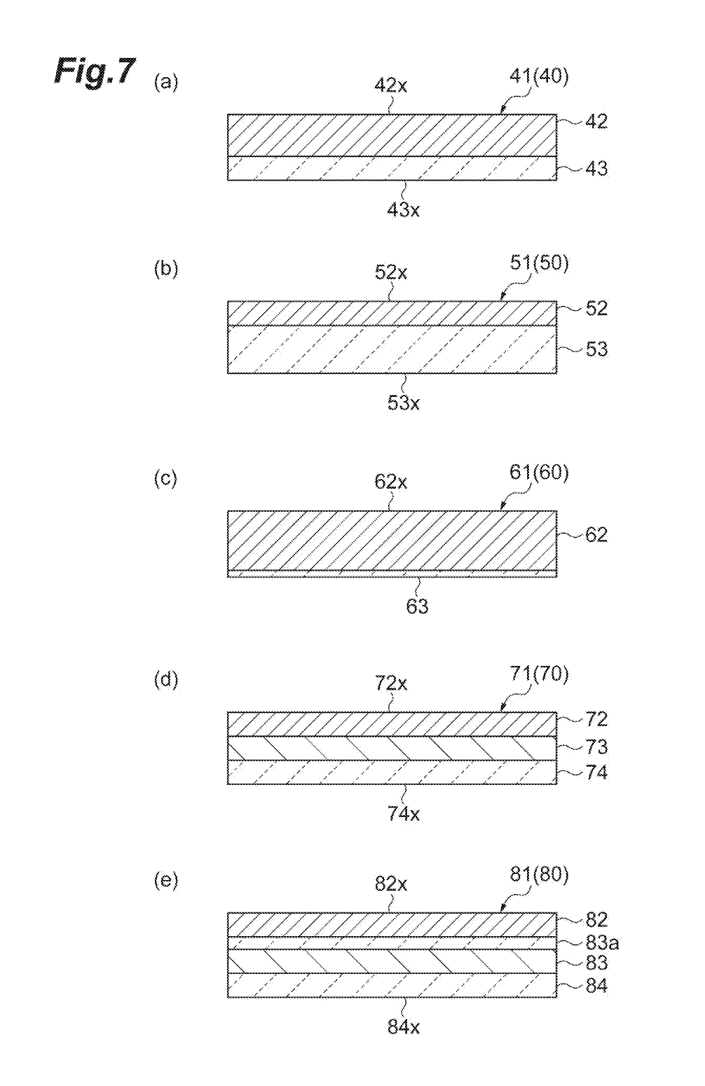

Further, a case in which the shield plate 20 has a three-layer structure in which the substrate layer 23, the blackbody layer 24, and the reflective layer 22 are stacked, and the substrate layer 23 is, for example, copper member (a copper plate or a copper layer) has been described, but the present invention is not limited thereto. That is, as in a shield plate 80 illustrated in FIG. 7(e), a base 81 may include a substrate layer 83, a blackbody layer 84 having a blackbody surface 84x as an outer surface, a heat insulating material 83a provided such that the substrate layer 83 is sandwiched between the heat insulating material 83a and the blackbody layer 84, and a reflective layer 82 provided so that the heat insulating material 83a is sandwiched between the reflective layer 82 and the substrate layer 83 and having a reflective surface 82x as an outer surface. By providing the heat insulating material 83a between the substrate layer 83 and the reflective layer 82, the amount of heat conduction of the substrate layer 83 to the reflective layer 82 can be smaller than the amount of heat conduction from the substrate layer 83 to the blackbody layer 84. Accordingly, the amount of thermal radiation of the blackbody surface can be larger than the amount of thermal radiation of the reflective surface. A fiber-based heat insulating material or a foam-based heat insulating material can be used as the heat insulating material 83a. Further, a heat insulating layer may be formed by providing a vacuum layer between the substrate layer 83 and the reflective layer 82 in place of the heat insulating material 83a.

Further, for example, as illustrated in FIGS. 7(a) and 7(b), the base of the shield plate may have a two-layer structure. The base 41 of the shield plate 40 in FIG. 7(a) includes a substrate layer 42 having a reflective surface 42x as an outer surface, and a blackbody layer 43 having a blackbody surface 43x as an outer surface, which is provided to overlap the substrate layer 42. The amount of thermal radiation of the blackbody layer 43 is larger than the amount of thermal radiation of the substrate layer 42. Accordingly, the amount of thermal radiation of the blackbody surface 43x and the amount of thermal radiation of the reflective surface 42x can be easily caused to be different from each other. Further, by the base 41 having a two-layer structure, it is easy to manufacture the shield plate. Copper (a copper plate or a copper layer) or gold (a gold plate or a gold layer) can be used as the substrate layer 42. A ceramic coating of the blackbody, for example, can be used as the blackbody layer 43.

A base 51 of a shield plate 50 in FIG. 7(b) includes a substrate layer 53 having a blackbody surface 53x as an outer surface, and a reflective layer 52 having a reflective surface 52x as an outer surface, which is provided to overlap the substrate layer 53. The amount of thermal radiation of the reflective layer 52 is smaller than the amount of thermal radiation of the substrate layer 53. Accordingly, the amount of thermal radiation of the blackbody surface 53x and the amount of thermal radiation of the reflective surface 52x can be easily caused to be different from each other. Further, due to the base 51 having a two-layer structure, it is easy to manufacture the shield plate. Carbon or graphene, for example, can be used for the substrate layer 53. Further, a gold plating, for example, may be used as the reflective layer 52.

Further, the shield plate may include only a substrate layer, as illustrated in FIG. 7(c). A base 61 of the shield plate 60 in FIG. 7(c) includes a substrate layer 62 having a reflective surface 62x as an outer surface. In the substrate layer 62, a surface opposite to the reflective surface 62x becomes a blackbody surface 63 due to a blackening treatment. Thus, by forming the blackbody surface by processing the substrate layer having the reflective surface, it is easier for the shield plate to be manufactured, and it is possible to reduce the number of components. Gold (such as a gold plate), for example, can be used as the substrate layer 62. In this case, the blackbody surface 63 subjected to the blackening treatment is blackened gold.

Further, as illustrated in FIG. 7(d), a base 71 of a shield plate 70 has a three-layer structure, and a substrate layer 73 having a thermoelectric element, a blackbody layer 74 having a blackbody surface 74x as an outer surface, and a reflective layer 72 having a reflective surface 72x as an outer surface may be stacked. The thermoelectric element is, for example a Peltier element, a Seebeck element, or a Thomson element. A black ceramic coating, for example, can be used as the blackbody layer 74. A gold plating, for example, may be used as the reflective layer 72. For example, when a Peltier element is used as the thermoelectric element, the substrate layer 73 absorbs heat at a junction between the substrate layer 73 and the reflective layer 72 that is gold plating and generates heat at a junction between the substrate layer 73 and the blackbody layer 74 that is a black ceramic coating when a current or a voltage is applied. Thus, the amount of thermal radiation of the blackbody surface of the blackbody layer 74 is larger than the amount of thermal radiation of the reflective surface of the reflective layer 72. When the substrate layer 73 having the thermoelectric element is used, a temperature controller (a temperature control unit) is electrically coupled to the thermoelectric element and applies a current or voltage to control the temperature of the shield plate 70. Accordingly, the temperature of the shield plate having the thermoelectric element can be easily and reliably controlled.

Further, the case in which the central shield portion 21z is in a blackbody state has been described, but the present invention is not limited thereto, at least the opposite shield portion (a blackbody portion) formed to face the opening in the blackbody surface may be in a blackbody state with respect to infrared rays, and the central shield portion may not necessarily be in a blackbody state.

### REFERENCE SIGNS LIST

1, 1E Measurement apparatus
11 Tester unit (signal input unit)
12 Objective lens (imaging unit, light guiding optical system)
13 Infrared camera (imaging unit, infrared detector)
14 Computer (calculation unit),
20, 20A, 20B, 20D, 40, 50, 60, 70, 80, 90 Shield plate
21, 21A, 21B, 21D, 41, 51, 61, 71, 81, 91 Substrate
21c, 21Ac, 21Bc, 21Dc Opening
21e, 21Ae, 21Be, 31D Opposite shield portion (blackbody portion)
21a, 42x, 52x, 62x, 91a Reflective surface
21b, 43x, 53x, 63, 91b Blackbody surface
21z Central shield portion (shield portion)
22, 52, 72, 82 Reflective layer
23, 42, 53, 62, 73, 83 Substrate layer
24, 43, 74, 84 Blackbody layer
28 Temperature controller (temperature control unit)
31, 31A, 31B Peripheral shield portion (blackbody portion)
83a Heat insulating material
CA Central axis
D Semiconductor apparatus (measurement target)
OA Optical axis

1: A shield plate used for non-contact measurement of a temperature of a measurement target, the shield plate comprising a base of which a temperature is adjustable,
wherein the base comprises:
a shield portion formed in the shield plate;
an opening formed around the shield portion; and
a blackbody portion formed on one surface of the base to comprise a portion opposite to the opening with the shield portion interposed therebetween and to radiate infrared rays.

2: The shield plate according to claim 1, wherein the opening is formed around the shield portion to be odd-fold rotationally symmetrical around the shield portion.

3: The shield plate according to claim 1, wherein the opening is formed in an annular shape around the blackbody portion.

4: The shield plate according to claim 1, wherein the opening is formed to decrease in size from the one surface of the base to the other surface of the base.

5: A measurement apparatus for performing non-contact measurement of a temperature of a measurement target, the measurement apparatus comprising:
the shield plate according to claim 1 disposed such that one surface of the base is opposite to the measurement target;
an optical system configured to guide infrared rays passing through the opening of the shield plate;
an infrared detector optically coupled to the optical system, configured to detect the guided infrared rays, and output a detection signal;
a temperature controller configured to control a temperature of the shield plate; and
calculator configured to calculate the temperature of the measurement target based on the detection signal,
wherein the shield plate is disposed such that the shield portion is located on an optical axis of the optical system.

6: The measurement apparatus according to claim 5, wherein the temperature controller controls the temperature of the base of the shield plate such that the temperature is controlled to be at least a first temperature and a second temperature different from the first temperature, and
the calculator calculates the temperature of the measurement target based on the detection signal at the first temperature and the detection signal at the second temperature.

7: The measurement apparatus according to claim 5, wherein the infrared detector is a two-dimensional infrared detector.
